(19) United States
(12) Patent Application Publication
(10) Pub. No.: US 2003/0182651 A1
(43) Pub. Date: Sep. 25, 2003

(54) Method of integrating software components into an integrated solution

(76) Inventors: Mark Secrist, Fort Collins, CO (US); Christopher John Peltz, Windsor, CO (US)

Correspondence Address: HEWLETT-PACKARD COMPANY, Intellectual Property Administration, P.O. Box 272400, Fort Collins, CO, 80527-2400, US

(21) Appl. No.: 10/104,593

(22) Filed: Mar. 21, 2002

(51) Int. Cl. G06F 9/44

(52) U.S. Cl. 717/120

(57) ABSTRACT

A method of integrating software components into an integrated solution, where those components were not expressly designed for interoperability, may include assessing said components, designing a flow among said components for said integrated solution and integrating said components. The method may also include attempting to re-host the components to a common platform.

### FIELD OF THE INVENTION

The present invention relates to the field of software. More specifically, the present invention relates to the field of integrated software components that were not expressly designed for interoperability into an integrated solution.

### BACKGROUND OF THE INVENTION

Computers, computer networks and computerized devices are now ubiquitous. We rely on them for such basic functions as record keeping, communication and a host of other applications.

Computing devices are driven by software. Because of our great dependence on computing devices, the demand for new and improved software solutions is equally great. Consequently, opportunities to successfully market new software come and go at tremendous speed. The need for new software with particular features and functions is near constant in a vast array of endeavors, and many providers strive to satisfy the needs and demands of users.

Additionally, with the advent of mobile computing devices, such as Personal Digital Assistants (PDAs), the urgency is great to create mobile software solutions. Such solutions must be created rapidly to meet increasing demand and time-to-market requirements.

The rate at which opportunities arise requires that applications be prototyped, built and deployed very rapidly. These time-to-market requirements are driving the “componentization” of application logic and functionality. This has caused many companies to first consider leveraging products delivered by other third parties before building such functionality themselves.

Consequently, it is critical to be able to build high-level solutions from the integration of these third party components. One preferred way to accomplish this objective is to host this total solution on a single platform. This results in the greatest flexibility, performance and scalability. However, this often introduces a level of complexity that can impede the development process and affect the overall quality of the final solution. The degree to which these independent applications are well integrated will determine how cohesive the final product will look from a user's perspective.

### SUMMARY OF THE INVENTION

The present invention provides, among other things, a method of integrating software components into an integrated solution where those components were not expressly designed for interoperability. Under principles of the present invention, such a method may include assessing said components, designing a flow among said components for said integrated solution and integrating said components. The method may also include attempting to re-host the components to a common platform

### BRIEF DESCRIPTION OF THE DRAWINGS

The accompanying drawings illustrate preferred embodiments of the present invention and are a part of the specification. Together with the following description, the drawings demonstrate and explain the principles of the present invention. The illustrated embodiments are examples of the present invention and do not limit the scope of the invention.

FIG. 1 is a flowchart illustrating a method of integrating components into a desired software solution where some or all of the components are provided by different providers or were not specifically designed for interoperability according to principles of the present invention.

FIG. 2 is a flowchart detailing an assessment step in the method illustrated in FIG. 1.

FIG. 3 is a flowchart detailing a technology assessment step in the method illustrated in FIG. 2

FIG. 4 is a flowchart detailing an integration design step in the method illustrated in FIG. 1.

FIG. 5 is a flowchart detailing an integration step in the method illustrated in FIG. 1.

FIG. 6 is a block diagram of a portal created using the integration methodology of the present invention.

FIG. 7 is a block diagram illustrating components of the portal illustrated in FIG. 6.

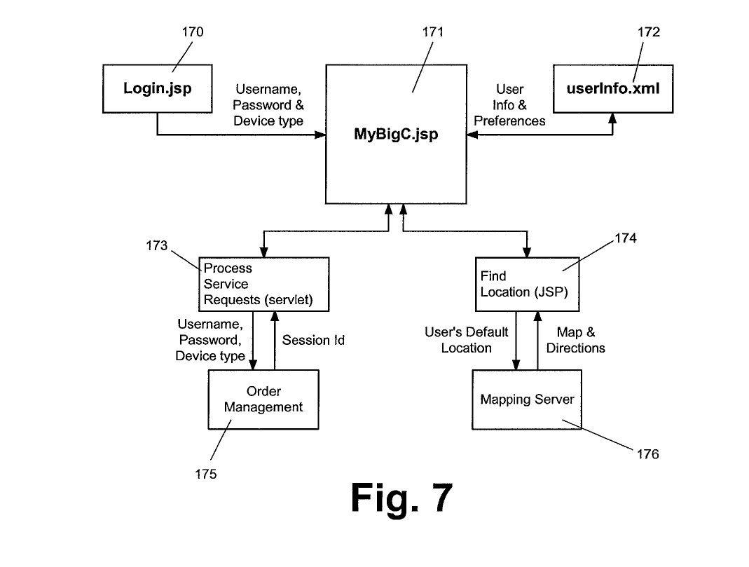

FIG. 8 is a block diagram illustrating a final architecture for the portal integration project according to principles of the present invention.

Throughout the drawings, identical reference numbers designate identical elements.

### DETAILED DESCRIPTION OF THE INVENTION

The present invention provides, among other things, a methodology for integrating components into a desired software solution where some or all of the components are provided by different providers or were not specifically designed for interoperability. As indicated above, the ability to integrate such components and leverage solutions provided by different providers can advantageously reduce the time and resources required to produce the desired solution.

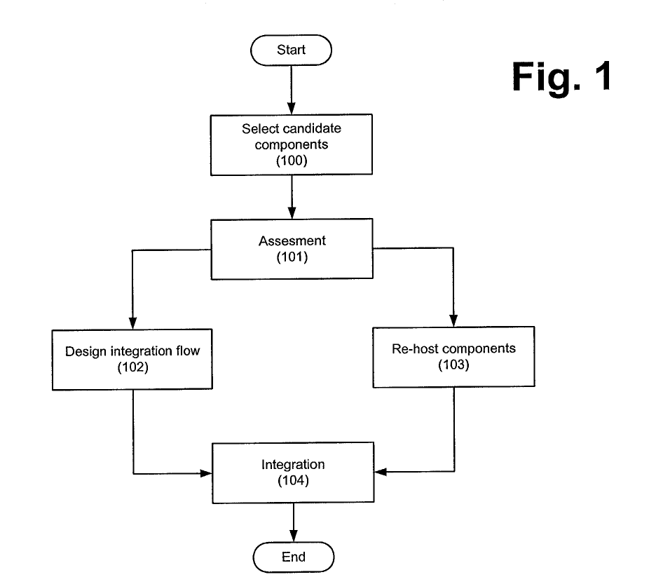

FIG. 1 is a flowchart illustrating an exemplary method of integrating components into a desired software solution according to principles of the present invention. As shown in FIG. 1, this method may include five steps.

The first step (100) is a selection of the candidate components to be integrated (100). This may include selecting alterative components among which a selection must be made.

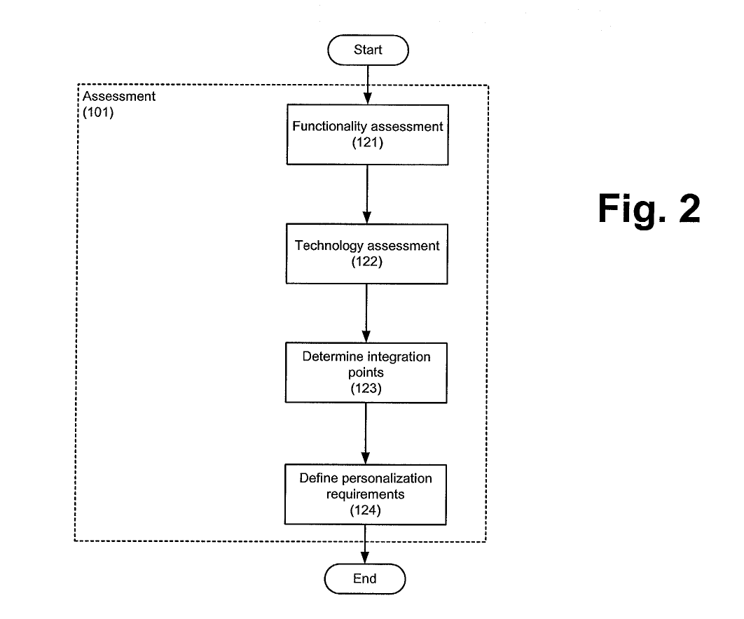

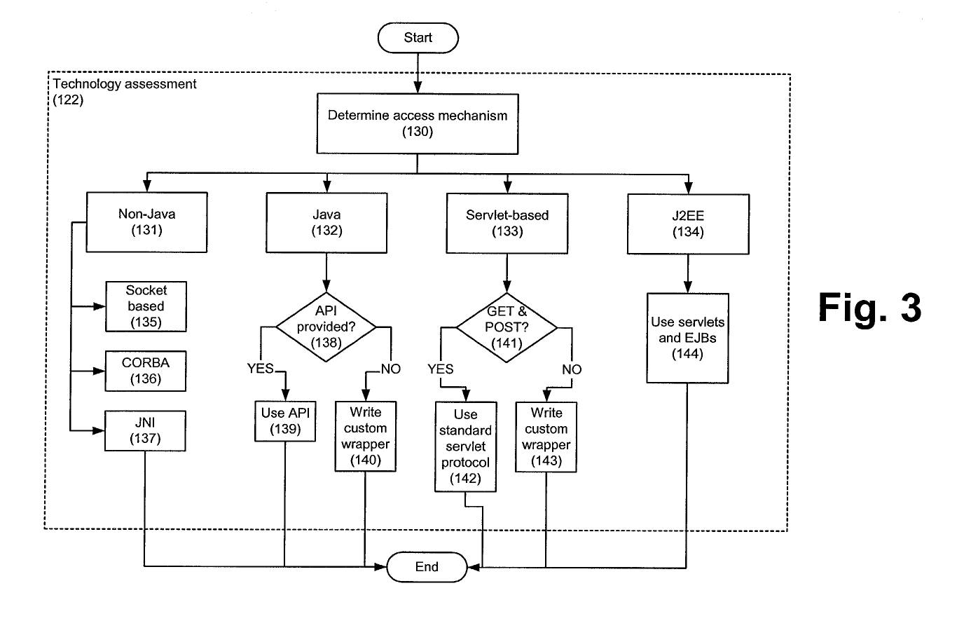

The next step is an assessment of the components that will be integrated to form the desired software solution. As used herein and in the appended claims, the term “component” refers to a self-contained software element that is to be integrated into a larger software solution. The assessment (101) of these components will be explained in further detail below with reference to FIGS. 2 and 3. During the assessment (101), some candidate components may be eliminated in favor of others.

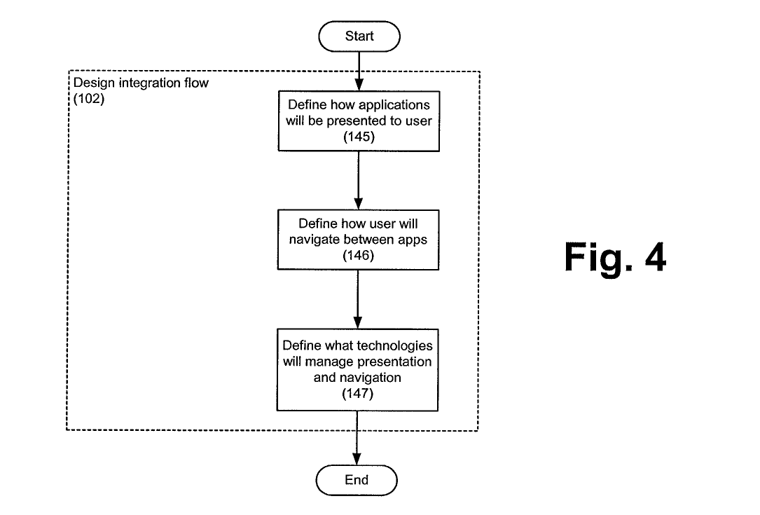

Following the assessment (101), the next two steps are designing the flow of the integration (102) and re-hosting the components of the integrated solution (103). As shown in FIG. 1, these two steps can be undertaken simultaneously, or in any sequence, following the assessment step (101). Both of these steps will be described in further detail below. Specifically, the step of designing the flow of the integration (102) will be described with reference to FIG. 4.

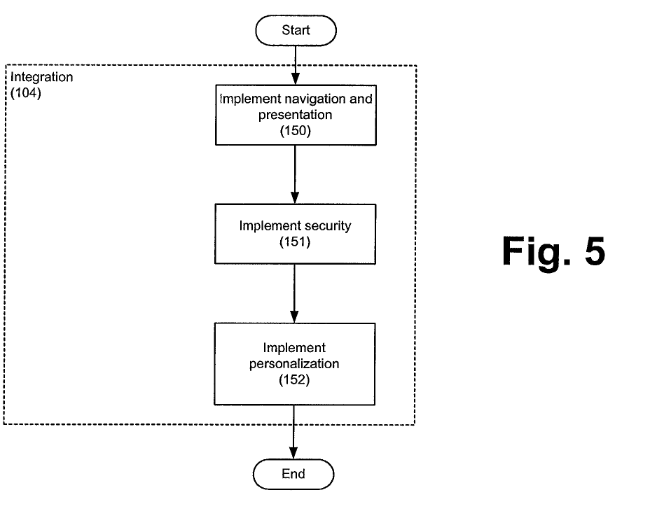

Finally, the method concludes with step of performing the actual integration (104). This step will be described in further detail below with reference to FIG. 5.

Referring to FIG. 2, the assessment step (101) is described in further detail. As shown in FIG. 2, the assessment step (101) may be divided in to four sub-steps (121-124).

First, a functionality assessment (121) must be made of the components to be integrated. This functionality assessment (121) preferably includes answering such questions as: (1) What specific functionality is provided by each product or component being considered? (2) What functionality of the component will be used in the integrated solution? (3) What browsers and/or devices are supported for accessing the component?

Following the functionality assessment (121), a technology assessment (122) is made. The details of this assessment are illustrated in FIG. 3. Referring to FIG. 3, the technology assessment (122) primarily includes determining the access mechanism (130) for the component under consideration. A component's access mechanism is the mechanism by which other software elements can access that component.

In the present environment, a number of alternative access mechanisms may be utilized by a component depending on the circumstances. FIG. 3 illustrates several likely scenarios for identifying an appropriate access mechanism for a component.

For example, as shown in FIG. 3, if the component is a non-Java component (131), one of three common access mechanisms may be available. First, the component may have a socket-based access mechanism (135).

Second, the component may have a CORBA-compliant access mechanism (136). CORBA stand for Common Object Request Broker Architecture and is an architecture that enables pieces of programs, called components or objects, to communicate with one another regardless of what programming language they were written in or what operating system they're running on. CORBA was developed by an industry consortium known as the Object Management Group (OMG).

Third, the component may have a Java Native Interface (JNI) (137). A JNI is a native programming interface for Java that allows Java code running inside a Java Virtual Machine to interoperate with applications and libraries written in other programming languages such as C, C++ and assembly language

Alternatively, if the component is a Java component (132), it may be provided with an Application Program Interface (API) (138). If the provider of the component has included an API, that API will likely be the access mechanism for that component (139). However, if no API is provided (138), it may be necessary to write a custom wrapper for the component (140). A custom wrapper is an access mechanism drafted specifically for a component to allow that component to be integrated into a larger, desired software solution.

Alternatively, the component may be a servlet or may be servlet-based (133). Commonly, servlets support an access mechanism that involves what are known as GET and POST commands. If the component under consideration for integration into a larger software solution supports both GET and POST commands (141), the standard servlet communications protocol can be used as the access mechanism for that component (142). Otherwise, it may again be necessary to write a custom wrapper for the component (143).

Finally, the component may be compatible with the Java 2 Platform, Enterprise Edition (J2EE) (134). If this is the case, one has great flexibility in integrating the component into a larger software solution. The J2EE component may includes servlets and Enterprise JavaBeans (EJBs).

The EJB standard is a server-side component architecture for writing reusable business logic and portable enterprise applications. Enterprise JavaBean components are written entirely in Java and run on any EJB compliant server. They are operating system, platform, and middleware independent, preventing vendor lock-in. The EJB architecture is inherently transactional, distributed, multi-tier, scalable, secure, and wire protocol neutral.

Returning to FIG. 2, after the technology assessment (122), the integration points are determined (123). In this step, the developer identifies the access mechanism for the desired functionality of each component. This choice is constrained by the access mechanism or mechanisms supported by the component as identified in the preceding technology assessment (122).

Finally, the developer defines the personalization requirements (124). In other words, the developer determined what information must be obtained from or on behalf of a user to personalize access to the functionality of the component. In some instances, this step maybe omitted if there is no personalization to be made in accessing the component. The developer may also explore what wrapper code will be required to support the personalization of the access to the component.

Referring to FIG. 4, FIG. 4 is a more detailed illustration of the step of designing the flow of the integration (102). In this step, the developer must design the workflow among the various components being integrated.

As shown in FIG. 4, the design of the flow may begin with defining how the application or applications will be presented to the user (145). This may include designing or selecting a user interface, including all the elements of the interface, the order or arrangement of their presentation, etc.

Next, the developer may define how the user will navigate within the application or among a number of applications that comprise the integrated solution (146). This may also implicate elements of the user interface and the mapping of such elements to the underlying logic.

Finally, the developer may define what technologies will manage the presentation defined in step (145) and the navigation defined in step (146). (147). For example, servlets may be used to manage the presentation of the solution and navigation within the solution. Alternatively, Java Server Pages (JSPs) may be used. JSPs are a server-side technology in which the Java server pages are an extension of the Java servlet technology. JSPs have dynamic scripting capability that works in tandem with HyperText Markup Language (HTML) code, separating the page logic from the static elements—the actual design and display of the page. Embedded in the HTML page, the Java source code and its extensions help make the HTML more functional, being used in dynamic database queries, for example. JSPs are not restricted to any specific platform or server.

In a third alternative, both servlets and JSPs can be used to manage presentation and navigation. For example, JSPs are well suited to manage presentation of the integrated solution, while servlets may be used as the controller or navigation technology.

Referring again to FIG. 1, the step of re-hosting (103) can be performed before, during or after the flow design step (102). The idea of re-hosting is to move all the components being integrated onto a common platform, i.e., the components are migrated to a new host environment, the common platform.

Simple components that are servlet-based are generally easy to re-host. More complex servlet-based components may be more difficult to re-host depending on the adherence of the component to common servlet specifications.

Components that are EJB-based may also be re-hosted. There are two types of EJBs of interest here, session beans and entity beans. Session beans are easier to re-host, usually requiring a mere re-packaging. Entity beans can be more difficult to re-host, especially when entity persistence is managed by the bean giving rise to a dependency on an underlying database.

In the end, re-hosting may not be possible and the integrated solution may require interaction between components on two or more platforms. This will then affect how the integration and wrapping codes are written. The integration and wrapping code will have to accommodate components on multiple platforms.

Finally, referring to FIG. 5, the last step in the process is the actual integration (104). Based on the results of the first three steps, the actual integration of the components is performed to generate an integrated solution.

As shown in FIG. 5, the actual integration may include implementing the navigation and presentation technologies selected previously (150). Next security is implemented (151). Finally, the personalization previously defined is implemented (152).

The result is an integrated solution that blends components which may not have been designed for interoperability. Obviously, the ability to integrate disparate components and thereby leverage existing logic can dramatically decrease the cost and time required for completing the desired solution.

In the remainder of this specification, we will discuss an actual example using the above-described methodology to integrate a variety of components that were not specifically designed for interoperability to create an integrated solution, in this case, a Web portal prototype. The integration experience outlined below is based on the Bluestone™ application server by Hewlett-Packard Co. (HP) and involves building a portal solution targeting both traditional Web browsers and wireless mobile devices, such as the Jornada™ PDA by HP.

The requirements for the prototype were based on a simple scenario that would allow the demonstration of components working together to provide a company portal. This portal could be accessed either by a traditional web browser or by a mobile device. The portal was designed to represent a small-scale hypothetical company BigC, which would offer content to both non-authenticated customers and also personalized content and functionality to various kinds of company employees who could access their own portal environment called MyBigC. External customers could view product information, sales representatives could oversee the order process, and delivery agents could manage the delivery of the order.

A user would access the portal entry point and have the ability to browse the publicly available web pages, such as a catalogue. If the user were a sales representative or a delivery agent, they could also choose to login to MyBigC with a valid username and password. After validating the user login, the user would be presented with a MyBigC page customized with their preferences and user type, and could then access the various services offered, including the ability to view customer orders or find map directions. The information and applications presented for the user would be customized based on information stored in a preferences file. For example, once a user logged into their portal area, they wouldn't have to log in again to access the functionality offered by the order management product. In addition, to make it easier to enter in the starting address for the mapping software, integration pages would need to be created to select starting addresses from a list of choices based on information stored in the preferences file.

To address the requirements of this prototype, the following three key functions were required: the capability to display site web pages to any device (transcoding), an application to manage product orders, and a service to provide mapping functionality to enable an employee to locate and navigate to customer sites quickly.

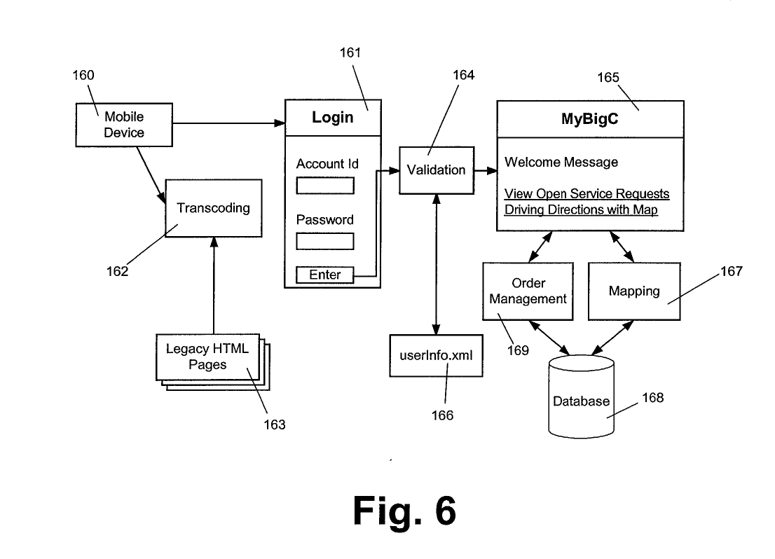

FIG. 6 illustrates how a user would access the specific features of the portal. Using a mobile device (160), or a traditional Web browser on a desktop or laptop computer, the user can access public web pages (163), which may also be pre-existing HTML pages. If necessary, these pages are transcoded (162) for use by the recipient device (160).

To access secured features, a user interface (161) allows the user to input identification and password information. These credentials are validated (164) based on user information (166) held by the system.

Upon validation, the user can access a secured page (165). The secured page (165) may provide order management (169) and mapping to customer sites (167). A corresponding database (168) supports these features of the secured page (165).

Given this conception of the desired portal, the goal is to integrate the best available components to produce the desired solution, even through the components may not have been expressly designed for interoperability.

The HP Bluestone™ IOE is a set of middleware components that are based on J2EE and extensible markup language (XML) standards. Included in this suite is HP Bluestone™, which includes a J2EE-compliant application server and a set of tools for targeting the mobile user.

In building the prototype, the following third-party components were selected: (1) A transcoding product, (2) A field service application using servlet technology, and (3) A J2EE-based application for retrieving maps and driving directions. Using the HP Bluestone™ IOE, these three partners provided key capabilities to rapidly prototype this portal solution illustrated in FIG. 6.

The transcoding product provides the capability to access a web site through a URL and automatically deliver it to any mobile device. The architecture requires all clients to go through the transcoder to access web sites. The transcoder would then intercept the HTTP request, determine the device type, and reformat the response appropriate for the device. Today, the transcoder is considered a stand-alone, Java-based product with no direct support for servlets or EJBs.

The field service application is a set of shrink-wrapped applications for the mobile field service employee. These applications can be customized to meet the needs of a variety to mobile users. In the case of this prototype, order management functionality was created. At the front of this architecture is a broker component developed using the Java servlet technology. Sitting between the broker and the database is a presentation manager component that provides functionality to handle multiple device types. This part of the architecture relies on key technologies like XML and extensible style language transformation (XSLT) to process and transform content into multiple presentation types. The fact that this product uses Java servlet technology enabled a relatively easy integration into the portal prototype.

The mapping product is a Java-based spatial application server providing support for geocoding, street routing, and display of spatial data. Users interact with the spatial server through basic HTTP query strings. These URL strings are sent to a servlet, which can be deployed on any web server supporting the Java servlet technology. The servlet then sends requests to a dispatcher, which invokes the necessary mapping functions provided by the mapping server. The product provides an EJB deployment option into any J2EE-compliant application server. Because J2EE applications are portable to any application server, the servlets and EJB components could be easily deployed into HP Bluestone, without modifications to the source code. With this architecture, all of the J2EE capabilities (e.g., scalability and reliability) could be leveraged. The product could also be easily customized since new servlets could be developed to directly interface with the mapping logic available in the mapping server components.

Given these pieces, integration of the components into the desired portal can commence. The first step is the assessment of the individual components (101; FIG. 1).

Before investing too heavily in prototyping an assumed architecture, it is well advised to take the time to better understand the individual components that will be integrated. Determine what functionality they provide in order to determine if the assumptions made earlier about each component and its role in the prototype scenario hold true (121; FIG. 2). It may be necessary to modify the scenarios or the architecture to better leverage the capabilities of available components. For example, the initial scenario and architecture had the transcoding server as a backend service that could be used to browse any universal resource locator (URL) from a PDA device. As it turned out, the transcoding server was not designed to be used in this way. After looking more closely at the functionality of the product, a decision was made to change the architecture and the scenario to place the transcoder at the front end of the prototype, transcoding legacy HTML pages. An alternative approach would be to search for another component that did provide the desired functionality.

The second aspect to assessment is to determine what technologies each component uses (122; FIG. 2). The technologies used will to some extent determine the level of integration that can be achieved and will also determine the approach used. For example, servlets typically have at most two integration points (doGet and doPost methods) while EJBs can provide much more flexibility in how they are invoked, enhancing the level of integration. Also, if the product is servlet, JSP, or EJB based, it is highly possible that it can be hosted on a single J2EE application server such as the HP Bluestone™ application server. Applications that do not use J2EE technologies can also be integrated but must offer some sort of API in order to do so and could introduce dependencies that would make it difficult to plug and play different solutions. Some of the technologies that could be used to integrate with non-J2EE products include J2EE connectors, other commercial Enterprise Application Integration (EAI) products, CORBA and Remote Method Invocation (RMI).

Once the technology assessment (122; FIG. 2) is complete it is then possible to determine the integration points (123; FIG. 2). Even when a J2EE technology such as servlets is used, it is important to determine whether both GET and POST mechanisms are supported. It is sometimes the case that an individual application may be designed to support either GET or POST but not both. It will be important to know this information when defining the flow between the individual applications.

Finally, based on what is known of the individual components, define a flow of the way these products will be presented and invoked from within the portal (102; FIG. 1). This will determine what glue code will need to be written in order to bring it all together. At this point, decisions will be made about what technologies will be used to provide the control flow, application wrapping and personalization. It is also necessary at this point to determine what devices will be supported since any glue code that is written to access the individual mobile applications must also support all the targeted devices.

Next, we re-host the applications to a single vendor's application server (103; FIG. 1). It is probable that the final solution will need to run on one or more application servers provided by a single vendor to minimize the cost of having to purchase and maintain application servers from multiple vendors, and eliminate the additional complexity of building and maintaining an application using different application servers. Based on the information gathered during the assessment (101; FIG. 1), the re-hosting steps will vary for the different J2EE technologies used.

It is important to realize that just because a particular component indicates support for only a specific J2EE application server, it doesn't mean the components can't be re-hosted. Often it is simply a matter of having the application certified for another vendor's application server platform. If a component is built using strictly the standard J2EE technologies, there is a high likelihood the product can be easily re-hosted. When products start to use features specific to a particular vendor's application server, chances are the re-hosting process will be more problematic.

Servlet-based applications can vary in their degree of complexity and therefore will vary in the degree of difficulty in re-hosting. Some of the re-hosting difficulties can be attributed to the lack of clear specifications on the way in which servlet applications are packaged and accessed by a web container. As a result, an individual application may be packaged and supported for a particular web container such as Apache JServ, however packaging and invocation mechanisms may be quite different for another web container. Therefore, it may be necessary to use more than one web container in the portal architecture. With the release of the Java Servlet 2.2 Specification, the servlet packaging model has become much more standardized, enabling better interoperability among web containers. The primary means for accomplishing this interoperability is through the Web Archive (WAR) file, which is a standard way of packaging web components such as HTML files, servlets and JSPs.

Re-hosting Enterprise Java Beans can likewise vary in complexity depending on whether session beans or entity beans were used and whether container-managed persistence or bean managed persistence was used for entity beans. This process may involve re-declaring such things as access control and transactional characteristics for business methods of the EJB. In the end, the re-deployment process will result in a Java Archive (JAR) file containing the application server specific deployment information and code. It is then simply a matter of registering this new set of EJBs with the target application server. Most application server vendors will provide tools to facilitate the re-deployment of EJBs into their application server. While re-deployment of session EJBs can be pretty straightforward, entity beans, and in particular bean-managed entity beans, are often much more complex to re-host. This is because the persistence code inside the entity bean is often targeted at a particular database or even worse, database pools that are uniquely defined by each application server.

Once the assessment and re-hosting effort has been completed, it is time to write the control code and any glue code necessary to wrap access to the various applications. This typically is where the majority of the integration work will take place (104; FIG. 5). In writing this control and glue code, three key issues need to be addressed.

First, implementation of personalization will need to take place (152; FIG. 5). This involves mapping the user authentication information to a pre-defined set of information and applications that will be presented on successful login. There are many different ways to achieve personalization ranging from a simple file-based solution to using more robust personalization functionality that can be purchased as an off-the-shelf component.

However, personalization can mean many things. On one level it addresses what information is presented and how it is presented. On another level, the user's information can be used to enhance the integration of the components. For example, consider the mapping component. As a stand-alone product, it might be designed to take a starting address and an ending address in order to generate a driving map with instructions. But if a given user has several pre-defined points of origination, part of the user input requirements for such things as address, city, state and zip code can be eliminated by allowing them to simply select which location they are starting from. This kind of personalization becomes even more important and useful in mobile devices where user input capabilities can be quite restrictive.

The second key issue to consider is making sure that content produced supports multiple devices (150; FIG. 5). This means building the infrastructure in the control and glue code to detect and present the correct type of content for the device making the request. In addition, navigation will likely be quite different depending on whether a web browser, a PDA or a Wireless Application Protocol (WAP) enabled phone is accessing the portal.

The third issue to be addressed is writing the glue or wrapper code in order to adapt the access methods provided by the component to the needs of the portal. While a component may be designed to be accessed using a specific servlet invocation mechanism such as POST, the design of the portal may require invocation via GET. As another example, a product may be designed to work as a combination of servlets and EJBs, however in the portal, it may be that glue code is designed to directly access the EJBs in order to tailor the behavior of the product to fit the needs of the portal.

While the original intent of the project was to re-host all possible components to the HP Bluestone™ IOE, this objective wasn't accomplished with field service application in the first pass of the prototype. This was due to the complexity of the product combined with the immaturity of some aspects of the servlet specification with regards to packaging of the servlet code and the way in which the web container accesses them. As a result, the project decided to continue to use JServ, which is the officially supported web container for the field service application.

Having multiple web containers did not pose any problems in the prototype architecture. The HP Apache Web server is capable of being configured to support access to both as long as the servlet invocation is done in distinctly different ways. This was accomplished by using a specific configuration for JServ that defined the servlet path as <host>/s/<servlet>. For servlets hosted by the HP Bluestone™ web container, a different servlet invocation mechanism was used.

The project also found that in the case of re-hosting session EJBs from a different application server to the HP Bluestone™ application server, the process was quite straightforward. This involved taking the basic EJB components (remote, home and implementation class files) and using the HP Bluestone™ J2EE Developer deployment tool to re-deploy into the Bluestone™ IOE.

In the case of the prototype, only a simple forms-based login capability (170) was required to obtain a user name and password that would be used by the main controller JSP (171) to authenticate the user and retrieve personalization information (172). The user-specific information (172) retrieved was also used by the wrapper code (171) to provide personalized access to the applications, in this case processing service requests (173) and finding a location (174).

The main purpose of the MyBigC controller JSP (171) was to use the information obtained at login to access and display personalized messages for the user, as well as present the list of applications available to the user. Inside the MyBigC controller (171), a Java Bean is used to retrieve and store user specific information. By declaring this class to have session scope using the ‘useBean’ JSP tag, this information can be used on all subsequent calls to the servlet (173) and JSP glue code wrapping both the field service application (175) and the mapping application (176). The following are small sections of the various functions provided by MyBigC.jsp, illustrating the use of the user login information to initialize the user session information and its later use to personalize the portal environment.

<jsp:useBean id=″userBean″ scope=″session″ class=″UserSession″ />
<%! String selection; %>
<%! String sourceFile=″bigc/userInfo.xml″; %>
<% //Capture user info from login an fetch personalized information

selection=request.getParameter(″accountId″);
userBean.setUserName(selection);
selection=request.getParameter(″password″);
userBean.setUserPassword(selection);
userBean.fetchUserInfo(userInfoFile);

%>
. . . .
<% // Display welcome and user message %>
Welcome, <jsp:getProperty name=″userBean″ property=″firstName″ />!
<jsp:getProperty name=″userBean″ property=″userMessage″ />
. . . .
// Additional personalization
. . . .

Finally, the work necessary to wrap the third party applications focused on improving access to these products based on the fact that certain information about that user can be leveraged. For example, the field service application typically requires a login step prior to presenting the initial screen. However, since the user has already logged in to the BigC portal, some mechanism was needed to bypass the login. This prototype assumed that the same login information was used to access the field service application as was used to log into the portal. If a different user ID and password were required, this information could be stored in the user information and accessed using the UserSession class discussed above. From the analysis phase, it was determined that not only was a user ID and password required to log into the field service application, but a session ID was also required. This session ID is obtained when a request for the login page is sent to the field service application.

In order to hide this operation and directly log in, bypassing the login page, a servlet was written. This servlet invoked the initial login screen, passing the User Agent supplied by the client device, and intercepting the return results. The session ID information was extracted from this return result and used to formulate the invocation of the login request, effectively bypassing the login screen in a way that was transparent to the user. One issue the project encountered was that the servlet originally intended to be invoked by the login screen was designed to be invoked using a POST mechanism and therefore didn't support GET type invocations. As a result, the project had to write an intermediate screen where all the login information was stored as hidden form fields. In that way access to the field service application could be done using an HTTP POST.

The following listings show how the servlet is invoked and how the servlet wraps the order management functionality provided by the field service application.

<!—From MyBigC.jsp, a line which would represent access to the Order Management as a
link
<a href=″/cgi-bin/SaCGI.cgi/SaServletEngine.class/bigcsvc?usr=<jsp:getProperty
name=″userBean″ property=″userName″ />&pwd=<jsp:getProperty name=″userBean″
property=″userPassword″/> View Open Service Requests </a>

public class ProcessOrderMgmtServlet extends HttpServlet {

public void doGet(HttpServletRequest request, HttpServletResponse response) {

// Get user info and User-Agent info
String usr = request.getParameter(″usr″);
String pwd = request.getParameter(″pwd″);
String agent = request.getHeader(″User-Agent″);
String orderMgmtUrl = “Some string representing the URL to the login page”;
// Invoke the login screen
URL url = new URL(orderMgmtUrl);
URLConnection c = url.openConnection( );
c.setRequestProperty(″User-Agent″,agent);
BufferedReader in = new BufferedReader(new InputStreamReader(c.getInputStream( )));
String line;
// Begin writing the intermediate page
response.setContentType(″text/html″);
PrintWriter out = new PrintWriter(response.getOutputStream( ));
out.println(″<html><head><Title>Order Managegment</title></head>″);
out.println(″<body><hl>BigC Field Service Application</hl>″);
// Process result page to get Session ID
while ((line = in.readLine( )) != null) {

if(line.indexOf(″<form ″) >= 0) {

out.println(line); // This will have the Session ID in it
out.println(″<input name=\″usr\″ type=\″hidden\″ value=\″″ + usr + ″\″>″);
out.println(″<input name=\″pwd\″ type=/544 ″hidden\″ value=\″″ + pwd + ″\″>″);

}

}
in.close( );
out.println(″<input type = \″submit\″ value = \″Proceed\″>″);
out.println(″</form>″);
out.println(″</body></html>″);
out.close( );

}

}

Wrapping access to the mapping functionality wasn't quite so complex. The main objective was to simplify the process of supplying all the elements of the starting and ending address based on user-specific information. As a result, the wrapper to the mapping functionality simply obtained a list of the pre-configured addresses from the user's profile and offered this as a selection list. JavaScript was used to detect when a user made a selection and store the elements of the address selected into their respective fields as if they were typed in. The user then simply had to select an address by name to have this information supplied to the mapping server. This process was used for the destination address as well. Recognizing that the user may want to supply a starting or ending address that isn't in their select list, the individual fields were still presented to allow them to enter the address by hand.

Because the final portal solution was made up of the integration of several applications, it is important to realize that device-specific presentation was also handled by these different applications, potentially in different ways. It is therefore worthwhile to take a look at how client agnosticism was achieved in various parts of the solution.

As has already been mentioned, this prototype included static HTML files representing the company's legacy HTML content. The transcoding product was used to handle any device specific transcoding for this content. The transcoding product was configured to act as the primary contact point for web content at the address representing the BigC Company. This request is ultimately passed to the HP Apache web server where the content actually resides. Currently, there is no configuration that can be done to alter or customize the handling of content, so all that is necessary is to configure the transcoder to map the URL the transcoding server responds to, to the URL of the real server where the content resides.

The controller and wrapper code written by the project was designed to automatically handle the creation of presentation formats primarily for traditional web browsers and for a web browser running on, for example, a PDA such as an HP Jornada. For this, the Dynamic Stylesheet Engine (DSE) component of HP Bluestone™ Total-e-Mobile was used. The DSE is capable of supporting client agnosticism in several different ways. At its most basic level, the DSE can be used to determine what type of device is making the request. A JSP could then use this information to forward the request to a device-specific JSP. This was in fact how the initial prototype used the DSE. Below is an example of how this was done for the main login screen.

<%@ page import=″SaApi.beans.SaDynamicDevices,SaApi.*″

info=″BigC Login″ errorPage=″errors.jsp″ %>

<% // Get the current device (as listed in saagents.xml)

// and if it′s a WAP phone, forward to the WML version

SaDynamicDevices dd = new SaDynamicDevices( );
String devtype = dd.getDeviceForCurrentAgent(true);
if (devtype.equals(″winCE″)) {
%><jsp:forward page=″Login_winCE_html.jsp″></jsp:forward>
<% }
//Otherwise assume it is HTML
else {

%><jsp:forward page=″Login_html.jsp″></jsp:forward>

<% }

However, there is much more that the DSE can do to achieve a greater degree of client agnosticism with much less work. Because the heart of the DSE contains an XSLT engine, the same SaDynamicDevices class used in the above example could be used to process an XML document using just a few lines of code, eliminating the need for having to forward the request to a device specific JSP. One way this capability can be exploited is to use an XML document to define the basic page layout, either as a static XML document or one that is dynamically generated by the UserSession bean based on information in the user's profile. Then XSLT stylesheets can be defined which can translate the XML page information into device-specific presentation. The project intends to explore this functionality further in future prototyping activities.

Finally, both third party applications provide their own mechanisms for achieving client agnosticism. Consequently, there will likely be some variability in which various aspects of the final solution present themselves on different devices. In fact, it is likely that there will be some differences in both the types of devices supported and the degree to which they are supported. This will be the case for any collection of applications that are integrated together into a solution such as this. As a result, the final portal solution will end up only supporting the least common denominator of devices among all the individual applications and the control and glue code provided.

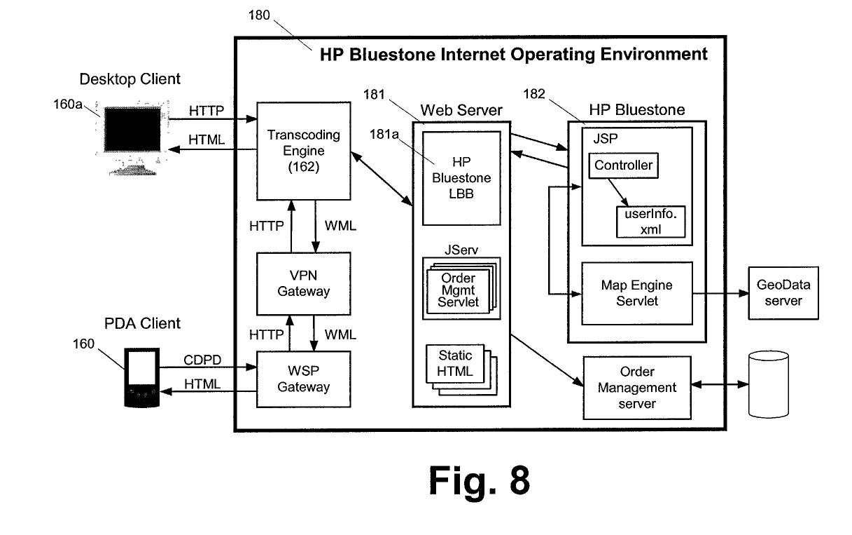

FIG. 8 illustrates the completed architecture for this prototype. The HP Apache-based web server (181) was used to receive HTTP requests from a desktop client (160a). The HP Load Balance Broker (LBB) module (181a) was added to the web server (181) to provide linear scalability across multiple instances of the application server. The HP Bluestone™ Total-e-Server product (182) provides the necessary container to manage the controller and the login JSPs (170, 171). Through the controller (171), the user could access the various services provided by the field service application and the mapping server. The HP Bluestone™ Total e-Server product (170) was then used to host the various components required by the components. This architecture allowed the prototype to leverage the important features of the J2EE specification, including scalability, reliability, security, and transaction management.

In evaluating how well each component integrated into an overall mobile solution, an important consideration was what access points were available for each product. From this prototype effort, it was discovered that there are a variety of architectures available, each offering a different level of integration capability with a given platform, such as the HP Bluestone™ IOE. These architectures can be organized into the following three categories:

1. Stand-alone Applications. These products generally run in their own process space and provide a specific pre-packaged solution to the end customer. Stand-alone applications are usually more difficult to integrate because they do not provide a well-defined interface, or API, to their application.

2. Servlet-based Applications. These products are designed to be accessible through a web browser. Because servlet-based applications are URL-based, they can provide an additional level of integration with other web-based applications. For example, a servlet could be developed to interact with the existing servlets providing by the partner.

3. J2EE-based Applications. Products that are fully compliant with the J2EE specification provide the best integration with a standard platform, such as the HP Bluestone™ IOE. J2EE-based applications can be easily deployed into the HP Bluestone™ application server and can take advantage of all the key J2EE capabilities, including flexibility, scalability, availability, and portability.

In the end, a J2EE-based application, one in which both servlet and EJBs are used, will yield the greatest flexibility and enable a much deeper level of integration. This is particularly true where many of the important components of an application are comprised of EJBs. This can potentially enable the controller and glue code to use these components to even further customize and tailor the presentation to suit the overall portal look and feel or even a particular user's preferences.

Even when servlets alone are used, it is important to ensure that support exists for both GET and POST HTTP requests. This will also allow more flexibility in the way the servlets are accessed. If possible, it is also helpful if some of the discrete functionality of the application can be exposed in some way such that more flexibility is given to the controller and glue code in how components of an application are accessed. What this enables is the ability to access information or a small piece of functionality from one component without having to go through the overhead of accessing functionality that may not be needed. Ultimately, this will enable a deeper level of integration than can be achieved by invoking the application from a couple of high-level access points.

The more complex the component is, the more difficult it is to re-host. This is true even if it is J2EE-based, particularly true of today's servlet-based applications because of the packaging issues. However, this will be resolved in time as the servlet and overall J2EE specifications become more specific on how J2EE-based web applications are packaged. In the meantime, attention should be given to packaging servlets in such a way that they support as many web containers as possible.

In building an integrated solution, thought should be given to trying to support as many of the applications as possible on one vendor's application server. There are several good reasons for this, not the least of which is the reduced cost of potentially having to obtain licenses from the vendors of the different application servers. In addition, the overall complexity of the solution will be reduced, thereby reducing the time to market, which ultimately translates to additional cost savings. And finally, the cost of maintaining this solution will also be reduced, both in terms of the cost of support contracts on the various application servers, as well as the cost of supporting the solution built on a variety of different application servers.

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A method of integrating software components into an integrated solution where said components were not expressly designed for interoperability, said method comprising:
assessing said components;
designing a flow among said components for said integrated solution;
attempting to re-host said components to a common platform; and
integrating said components.

2. The method of claim 1, further comprising selecting a set of candidate components prior to said assessing said components.

3. The method of claim 2, wherein said step of assessing said components further comprises selecting between alternative components in said set of candidate components.

4. The method of claim 1, wherein said step of assessing said components further comprises determining what functionality each component will provide within said integrated solution.

5. The method of claim 1, wherein said step of assessing said components further comprises determining what access mechanism technology is supported by each component to communicate.

6. The method of claim 5, further comprising determining what access mechanism will be used within said integrated solution to communicate with each component.

7. The method of claim 6, wherein said determining what access mechanism will be used within said integrated solution to communicate with each component comprises writing a custom wrapper for a component.

8. The method of claim 1, wherein said step of assessing said components further comprises defining what information must be obtained from a user to personalize access to at least some functions of said integrated solution.

9. The method of claim 1, wherein said step of designing said flow further comprises defining how components within said integrated solution will be presented to a user.

10. The method of claim 9, wherein said step of designing said flow further comprises defining how a user will navigate among components of said integrated solution.

11. The method of claim 10, wherein said step of designing said flow further comprises selecting technologies to manage presentation of and navigation within said integrated solution.

12. The method of claim 11, wherein technologies used to manage presentation of and navigation within said integrated solution include servlets.

13. The method of claim 11, wherein technologies used to manage presentation of and navigation within said integrated solution include Java Server Pages.

14. The method of claim 1, wherein said step of attempting to re-host said components further comprises successfully re-hosting at least one component to said common platform.

15. The method of claim 1, wherein said step of attempting to re-host said components further comprises re-hosting servlet-based components.

16. The method of claim 1, wherein said step of attempting to re-host said components further comprises re-hosting Enterprise Java Beans.

17. The method of claim 1, wherein said step of integrating said components further comprises implementing presentation of said integrated solution and navigation within said integrated solution.

18. The method of claim 1, wherein said step of integrating said components further comprises implementing security.

19. The method of claim 1, wherein said step of integrating said components further comprises implementing personalization features of said integrated solution.

20. The method of claim 1, wherein said integrated solution is a portal for access by either a Web browser or wireless mobile client device.

21. A method of integrating software components into an integrated solution where said components were not expressly designed for interoperability, said method comprising:
assessing said components;
designing a flow among said components for said integrated solution; and
integrating said components.

22. The method of claim 21, further comprising selecting a set of candidate components prior to said assessing said components.

23. The method of claim 22, wherein said step of assessing said components further comprises selecting between alternative components in said set of candidate components.

24. The method of claim 21, wherein said step of assessing said components further comprises determining what functionality each component will provide within said integrated solution.

25. The method of claim 21, wherein said step of assessing said components further comprises determining what access mechanism technology is supported by each component to communicate.

26. The method of claim 25, further comprising determining what access mechanism will be used within said integrated solution to communicate with each component.

27. The method of claim 26, wherein said determining what access mechanism will be used within said integrated solution to communicate with each component comprises writing a custom wrapper for a component.

28. The method of claim 21, wherein said step of assessing said components further comprises defining what information must be obtained from a user to personalize access to at least some functions of said integrated solution.

29. The method of claim 21, wherein said step of designing said flow further comprises defining how components within said integrated solution will be presented to a user.

30. The method of claim 29, wherein said step of designing said flow further comprises defining how a user will navigate among components of said integrated solution.

31. The method of claim 30, wherein said step of designing said flow further comprises selecting technologies to manage presentation of and navigation within said integrated solution.

32. The method of claim 31, wherein technologies used to manage presentation of and navigation within said integrated solution include servlets.

33. The method of claim 31, wherein technologies used to manage presentation of and navigation within said integrated solution include Java Server Pages.

34. The method of claim 21, further comprising re-hosting at least one of said components to a common platform.

35. The method of claim 34, wherein said step of re-hosting said components further comprises re-hosting servlet-based components.

36. The method of claim 34, wherein said step of re-hosting said components further comprises re-hosting Enterprise Java Beans.

37. The method of claim 21, wherein said step of integrating said components further comprises implementing presentation of said integrated solution and navigation within said integrated solution.

38. The method of claim 21, wherein said step of integrating said components further comprises implementing security.

39. The method of claim 21, wherein said step of integrating said components further comprises implementing personalization features of said integrated solution.

40. The method of claim 21, wherein said integrated solution is a portal for access by either a Web browser or wireless mobile client device.

41. A suite of software tools stored on media for storing computer-readable instructions, said suite being used to integrate software components into an integrated solution where said components were not expressly designed for interoperability, said suite comprising:
at least one tool for assessing said components;
at least one tool for defining a flow among said components for said integrated solution; and
at least one tool for integrating said components.

42. The suite of claim 41, wherein said tool for assessing said components is configured to assess multiple components from a set of candidate components to allow selection between alternative components in said set of candidate components.

42. The suite of claim 41, wherein said tool for assessing said components is configured to assist a developer in determining what functionality each component will provide within said integrated solution.

43. The suite of claim 41, wherein said tool for assessing said components assists a developer to identify what access mechanism technology is supported by each component to communicate.

44. The suite of claim 43, wherein said tool for defining a flow allows a developer to specify what access mechanism will be used within said integrated solution to communicate with each component.

45. The suite of claim 41, wherein said tool for integrating said components further comprises a tool for writing a custom wrapper for a component.

46. The suite of claim 41, wherein said tool for assessing said components further comprises a tool for defining what information must be obtained from a user to personalize access to at least some functions of said integrated solution.

47. The suite of claim 41, wherein said tool for designing said flow further comprises a tool for defining how components within said integrated solution will be presented to a user.

48. The suite of claim 41, wherein said tool for designing said flow further comprises a tool for defining how a user will navigate among components of said integrated solution.

49. The suite of claim 41, wherein said tool for designing said flow further comprises a tool for selecting technologies to manage presentation of and navigation within said integrated solution.

50. The suite of claim 49, wherein technologies used to manage presentation of and navigation within said integrated solution include servlets.

51. The suite of claim 49, wherein technologies used to manage presentation of and navigation within said integrated solution include Java Server Pages.

52. The suite of claim 41, further comprising at least one tool for re-hosting at least one of said components to a common platform.

52. The suite of claim 52, wherein said tool for re-hosting said components further comprises a tool for re-hosting servlet-based components.

53. The suite of claim 52, wherein said tool for re-hosting said components further comprises a tool for re-hosting Enterprise Java Beans.

54. The suite of claim 41, wherein said tool for integrating said components further comprises a tool for implementing presentation of said integrated solution and navigation within said integrated solution.

55. The suite of claim 41, wherein said tool for integrating said components further comprises a tool for implementing security.

56. The suite of claim 41, wherein said tool for integrating said components further comprises a tool for implementing personalization features of said integrated solution.

57. The suite of claim 41, wherein said integrated solution is a portal for access by either a Web browser or wireless mobile client device.

58. A system for integrating software components into an integrated solution where said components were not expressly designed for interoperability, said system comprising:
means for assessing said components;
means for designing a flow among said components for said integrated solution; and
means for integrating said components.

59. The system of claim 58, further comprising means for selecting a set of candidate components prior to said assessing said components.

60. The system of claim 59, wherein said means for assessing said components further comprise means for selecting between alternative components in said set of candidate components.

61. The system of claim 58, wherein said means for assessing said components further comprise means for determining what functionality each component will provide within said integrated solution.

62. The system of claim 58, wherein said means for assessing said components further comprise means for determining what access mechanism technology is supported by each component to communicate.

63. The system of claim 62, further comprising means for determining what access mechanism will be used within said integrated solution to communicate with each component.

64. The system of claim 63, wherein said means for determining what access mechanism will be used within said integrated solution to communicate with each component comprise means for writing a custom wrapper for a component.

65. The system of claim 58, wherein said means for assessing said components further comprise means for defining what information must be obtained from a user to personalize access to at least some functions of said integrated solution.

66. The system of claim 58, wherein said means for designing said flow further comprises defining how components within said integrated solution will be presented to a user.

67. The system of claim 66, wherein said means for designing said flow further comprise means for defining how a user will navigate among components of said integrated solution.

68. The system of claim 66, wherein said means for designing said flow further comprise means for selecting technologies to manage presentation of and navigation within said integrated solution.

69. The system of claim 68, wherein technologies used to manage presentation of and navigation within said integrated solution include servlets.

70. The system of claim 68, wherein technologies used to manage presentation of and navigation within said integrated solution include Java Server Pages.

71. The system of claim 58, further comprising means for re-hosting at least one of said components to a common platform.

72. The system of claim 71, wherein said means for re-hosting said components further comprise means for re-hosting servlet-based components.

73. The system of claim 71, wherein said means for re-hosting said components further comprise means for re-hosting Enterprise Java Beans.

74. The system of claim 58, wherein said means for integrating said components further comprise means for implementing presentation of said integrated solution and navigation within said integrated solution.

75. The system of claim 58, wherein said means for integrating said components further comprise means for implementing security.

76. The system of claim 58, wherein said means for integrating said components further comprise means for implementing personalization features of said integrated solution.

77. The system of claim 58, wherein said integrated solution is a portal for access by either a Web browser or wireless mobile client device.

78. A system for integrating software components into an integrated solution where said components were not expressly designed for interoperability, said system comprising:
at least one computer on which said components are assessed;
a tool on said computer for designing a flow among said components for said integrated solution; and
a tool on said computer for preparing glue code for integrating said components.

79. The system of claim 78, wherein operation of said system comprises selecting a set of candidate components as part of said assessment of said components.

80. The system of claim 79, wherein said assessment of said components further comprises selecting between alternative components in said set of candidate components.

81. The system of claim 78, wherein said assessment of said components further comprises determining what functionality each component will provide within said integrated solution.

82. The system of claim 78, wherein said assessment of said components further comprises determining what access mechanism technology is supported by each component to communicate.

83. The system of claim 78, wherein said tool for designing said flow allows a developer to determine what access mechanism will be used within said integrated solution to communicate with each component.

84. The system of claim 83, wherein said determination of what access mechanism will be used within said integrated solution to communicate with each component comprises a system form writing a custom wrapper for a component.

85. The system of claim 78, wherein said tool for designing a flow comprises a tool for defining what information must be obtained from a user to personalize access to at least some functions of said integrated solution.

86. The system of claim 78, wherein said tool for designing said flow further comprises a tool for defining how components within said integrated solution will be presented to a user.

87. The system of claim 86, wherein said tool for designing said flow further comprises a tool for defining how a user will navigate among components of said integrated solution.

88. The system of claim 87, wherein said tool for designing said flow further comprises a tool for selecting technologies to manage presentation of and navigation within said integrated solution.

89. The system of claim 88, wherein technologies used to manage presentation of and navigation within said integrated solution include servlets.

90. The system of claim 88, wherein technologies used to manage presentation of and navigation within said integrated solution include Java Server Pages.

91. The system of claim 78, further comprising a common platform for re-hosting at least one of said components.

92. The system of claim 91, wherein said common platform re-hosts servlet-based components.

93. The system of claim 91, wherein said common platform re-hosts Enterprise Java Beans.

94. The system of claim 78, wherein said glue code comprises implementation of technologies for presentation of said integrated solution and navigation within said integrated solution.

95. The system of claim 78, wherein said glue code further comprises security features.

96. The system of claim 78, wherein said glue code further comprises implementation of personalization features of said integrated solution.

97. The system of claim 78, wherein said integrated solution is a portal for access by either a Web browser or wireless mobile client device.
